(19) United States
(12) Patent Application Publication
(10) Pub. No.: US 2017/0083992 A1
(43) Pub. Date: Mar. 23, 2017

(54) Method of Facilitating Business Transactions

(71) Applicant: Russell T. Buchanan, Asheville, NC (US)

(72) Inventor: Russell T. Buchanan, Asheville, NC (US)

(21) Appl. No.: 15/269,261

(22) Filed: Sep. 19, 2016

Related U.S. Application Data
(60) Provisional application No. 62/220,554, filed on Sep. 18, 2015.

(51) Int. Cl. G06Q 50/16; G06Q 10/10; G06Q 20/10

(52) U.S. Cl. CPC G06Q 50/16; G06Q 20/10; G06Q 10/10

(57) ABSTRACT

A method for facilitating the completion of a real estate transaction over the Internet includes the steps of presenting at least one manually-entered datum on an electronic document to a first party; providing a first party field adjacent to each of the at least one manually-entered datums for entering comments on the electronic document; transmitting the electronic document to a second party; providing a second party field adjacent to each of the first party fields for entering comments on the electronic document; transmitting the electronic document to the first party; and creating and storing a digital copy of each of the transmitted electronic documents as a HyperText Markup Language (HTML) file.

### BACKROUND OF THE INVENTION

This application is based on and claims priority to provisional patent application No. 62/220,554 filed on Sep. 18, 2015.

### FIELD OF THE INVENTION

This invention relates to platforms for conducting transactions between two or more entities and, more particularly, to an electronic platform for conducting real estate transactions between two or more parties.

### DISCUSSION OF THE RELATED ART

Business transactions go through a number of different phases wherein reference to one or more of the previous phases is necessary in order to effectuate the final agreement in its entirety. An issue arises wherein the parties to any given transaction have different routines in arriving at the final agreement, whereby oversights and other impactful miscommunications can easily occur. Considering the considerable amounts of paperwork exchanging hands among the many people involved in such transactions, such as real estate transactions, there are a number of instances wherein such miscommunications can and do occur.

Accordingly, in view of the problems outlined above, there exists a need for a standardized platform for documenting interaction between multiple parties to a transaction, such as a repair request resulting from an inspection for real estate transactions or other transactions wherein negotiating is still required as a result from an inspection. The platform outlined herein eliminates confusion by documenting the request from one party (or their agent) to another party and the responses from the other party or their agent. The platform reduces liability and further keeps the process moving by eliminating the need for face to face negotiations or the many inconsistent variables used to request and respond to items identified in the home inspection report. The platform facilitates the final negotiating process and records the back and forth negotiating.

### SUMMARY OF THE INVENTION

In accordance with one embodiment of the present invention there is provided a method of facilitating the completion of a real estate transaction over the Internet includes the steps of presenting at least one manually-entered datum on an electronic document to a first party; providing a first party field adjacent to each of the at least one manually-entered datums for entering comments on the electronic document; transmitting the electronic document to a second party; providing a second party field adjacent to each of the first party fields for entering comments on the electronic document; transmitting the electronic document to the first party; and creating and storing a digital copy of each of the transmitted electronic documents as a HyperText Markup Language (HTML) file.

In accordance with another embodiment of the present invention there is provided a method of facilitating the completion of a real estate transaction over the Internet includes the steps of presenting at least one manually-entered datum on an electronic document to a first party; providing a first party field adjacent to each of the at least one manually-entered datums for entering comments on the electronic document; transmitting the electronic document to a second party; providing a second party field adjacent to each of the first party fields for entering comments on the electronic document; transmitting the electronic document to the first party and a third party; providing a third party field adjacent to each of the first and second party fields for entering comments on the electronic document; transmitting the electronic document to the first party and the second party; and creating and storing a digital copy of each of the transmitted electronic documents as a HyperText Markup Language (HTML) file.

### BRIEF DESCRIPTION OF THE DRAWINGS

For a fuller understanding of the nature of the present invention, reference should be made to the following detailed description, taken in conjunction with the accompanying figures in which:

FIG. 1 illustrates a sequential flow chart illustration of a preferred embodiment of the invention;

FIG. 2 illustrates a sequential flow chart illustration of a preferred embodiment of the invention;

FIG. 3 illustrates a screenshot taken from the transaction platform, wherein an inspection report is shown and further including comments relating thereto; and

FIG. 4 illustrates a menu of selectable actions for a party of the transaction for choosing which action is preferred in view of a request.

Like reference numerals refer to like parts throughout the several views of the drawings.

### DETAILED DESCRIPTION OF THE PREFERRED EMBODIMENTS

Referring to the several views of the drawings, there is provided a method of facilitating the completion of a transaction over the Internet of the present invention for use in conjunction with transactions, such as real estate transaction, is shown and is generally indicated herein as 10.

Generally, the method 10 described herein refers to an electronic platform allowing two or more parties of a transaction, e.g., a real estate transaction, to review the inspection items and to identify what item or items from the inspection report are a concern. By way of the real estate transaction example, the parties can subsequently inquire and otherwise communicate as to matters of repair, replacement and/or funds relating to a particular inspection item. This can be done between a first party (and/or their agent on behalf of the first party) and a second party (and/or their agent acting on behalf of the second party). Once one party identifies one or more items of concern, a summary is created to send to the other party. The platform permits the receiving party to agree or disagree and counter (if so desired) with action or money in a different amount to effectuate negotiation in view of the inspection report. This back and forth process can continue indefinitely until all parties are in agreement. The platform facilitates the process by automatically taking the customer through the inspection report one item at a time and prompting the customer to accept or “Make Request Type” and electronically stores a copy of the back and forth requests and counteroffers.

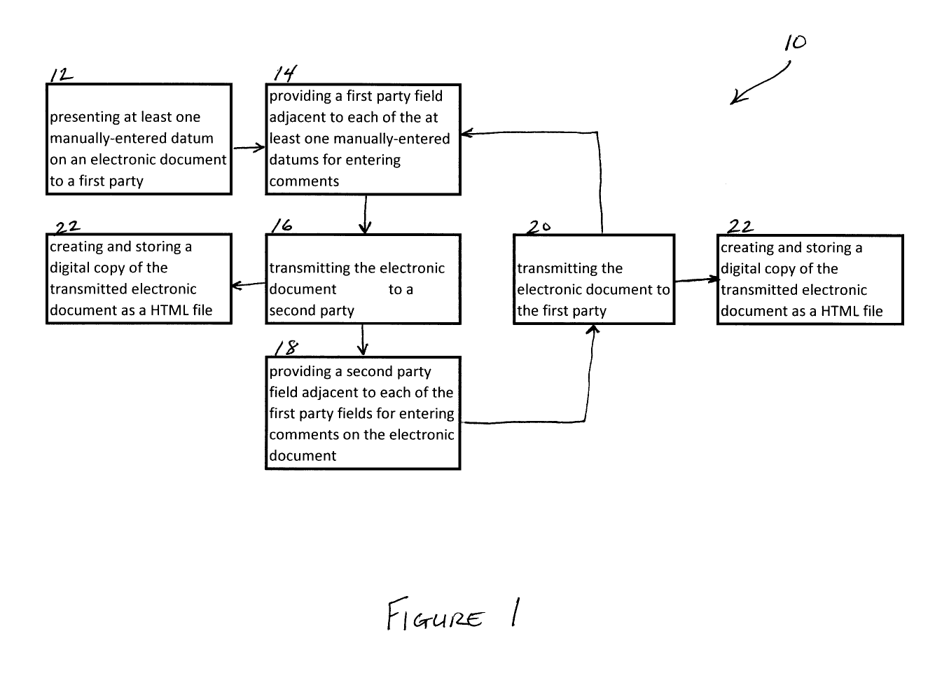

Referring to FIG. 1, the method 10 for facilitating the completion of a real estate transaction over the Internet includes the following steps 12-22. Step 12, presenting at least one manually-entered datum on an electronic document to a first party. Step 14, providing a first party field adjacent to each of the at least one manually-entered datums for entering comments on the electronic document. Step 16, transmitting the electronic document to a second party. Step 18, providing a second party field adjacent to each of the first party fields for entering comments on the electronic document. Step 20, transmitting the electronic document to the first party. Step 22, creating and storing a digital copy of each of the transmitted electronic documents as a HyperText Markup Language (HTML) file. Thereafter, this process reverts back to Step 14 if there remain items which have not been agreed upon.

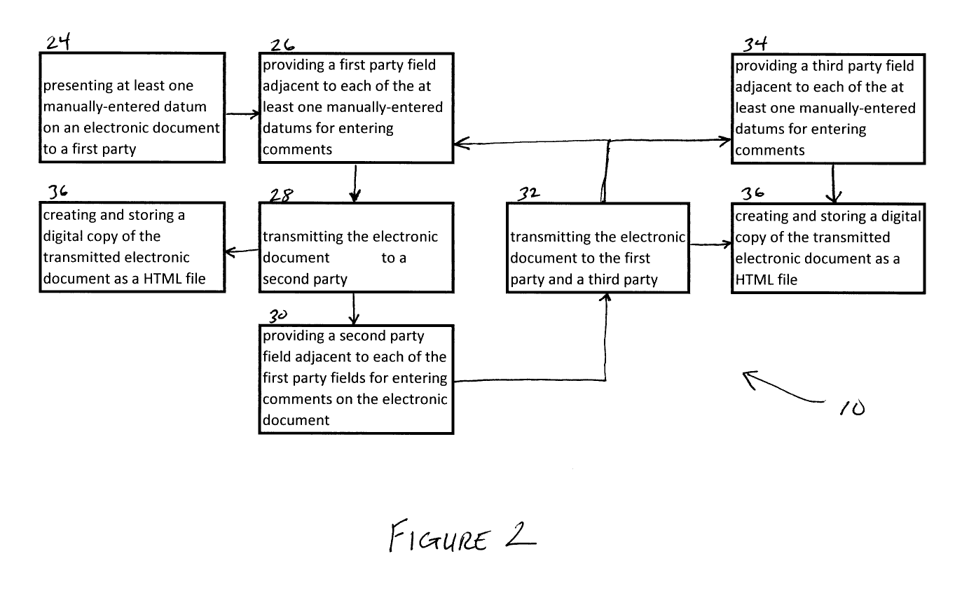

Referring to FIG. 2, another embodiment of the method 10 for facilitating the completion of a real estate transaction over the Internet includes the following steps 24-38. Step 24, presenting at least one manually-entered datum on an electronic document to a first party. Step 26, providing a first party field adjacent to each of the at least one manually-entered datums for entering comments on the electronic document. Step 28, transmitting the electronic document to a second party. Step 30, providing a second party field adjacent to each of the first party fields for entering comments on the electronic document. Step 32, transmitting the electronic document to the first party and a third party. Step 34, providing a third party field adjacent to each of the first and second party fields for entering comments on the electronic document. Step 36, creating and storing a digital copy of each of the transmitted electronic documents as a HyperText Markup Language (HTML) file. Thereafter, this process reverts back to Step 26 if there remain items which have not been agreed upon.

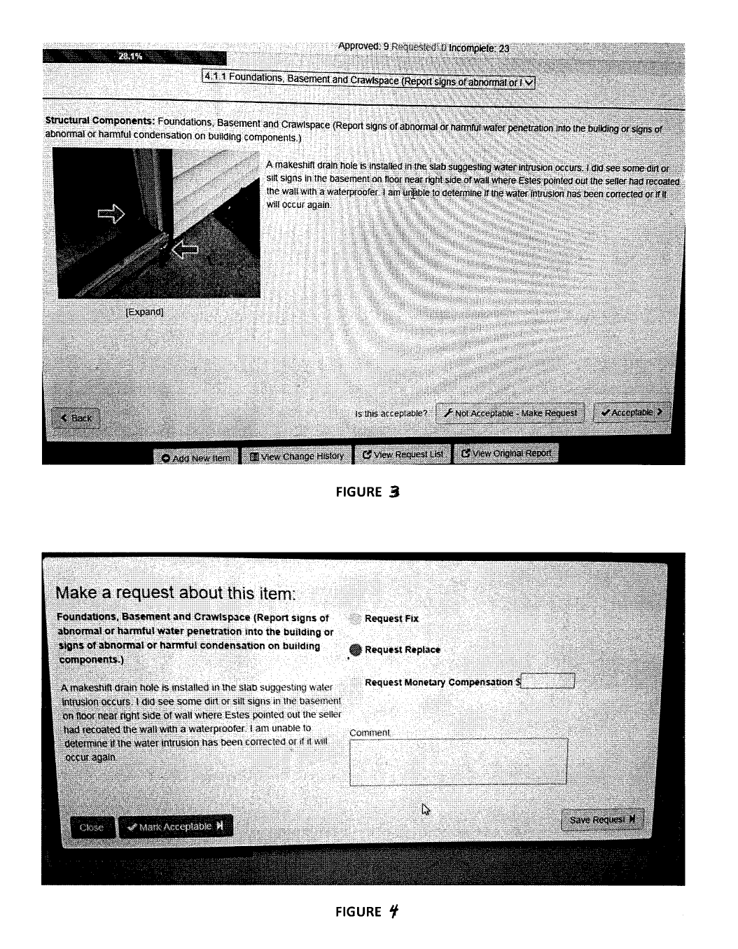

Referring to FIG. 3, at the bottom of the platform display is a row of action items, including “Add new item, View Change History, View Request list, View original inspection report,” and more particularly described below:
a. Add New Item: Allows the person participating to add an item to the request process that wasn't included in the original inspection or is a result of the actual inspection.
b. View Change History: Allows anyone involved to see when each action was submitted and by whom, as well as whether the action was changed.
c. View Request list: This action will display the entire list of requests that was generated by this process.
d. View original report: This displays the actual inspection report that was created by the inspector.

The header area describes the actual item by number and the section of the report it came from with the ability to extract the next item and the inspector's comments or findings anywhere in the report by the drop down menu. The Footer area has action requirements by the person participating. “Is this Acceptable?” is the first action item. The party participating can answer “Acceptable” or they can select “Not Acceptable” in which case another action occurs (see FIG. 4).

Referring to FIG. 4, user selectable options include “Request Fix, Request Replace, or Request Monetary Compensation.” The participating party can also type written comments in addition to the automated actions of the program.

While the present invention has been shown and described in accordance with several preferred and practical embodiments, it is recognized that departures from the instant disclosure are contemplated within the spirit and scope of the present invention.

What is claimed is:

1. A method of facilitating the completion of a real estate transaction over the Internet, said method comprising the steps of:
presenting at least one manually-entered datum on an electronic document to a first party;
providing a first party field adjacent to each of said at least one manually-entered datums for entering comments on said electronic document;
transmitting said electronic document to a second party;
providing a second party field adjacent to each of said first party fields for entering comments on said electronic document;
transmitting said electronic document to the first party; and
creating and storing a digital copy of each of said transmitted electronic documents as a HyperText Markup Language (HTML) file.

2. The method recited in claim 1 further comprising the steps of:
uploading at least one digital picture file; and
storing said at least one digital picture file on said digital copy of each of said transmitted electronic documents.

3. The method as recited in claim 2 wherein said at least one digital picture file is a digital video file.

4. The method as recited in claim 1 wherein said at least one manually-entered datum is an inspection report.

5. The method as recited in claim 1 further comprising the step of allowing each of the first and second parties to accept the at least one manually-entered datum.

6. The method as recited in claim 1 further comprising the step of allowing each of said first and second parties to accept or reject the opposing party's comments.

7. A method of facilitating the completion of a real estate transaction over the Internet, said method comprising the steps of:
presenting at least one manually-entered datum on an electronic document to a first party;
providing a first party field adjacent to each of said at least one manually-entered datums for entering comments on said electronic document;
transmitting said electronic document to a second party;
providing a second party field adjacent to each of said first party fields for entering comments on said electronic document;
transmitting said electronic document to the first party and a third party;
providing a third party field adjacent to each of said first and second party fields for entering comments on said electronic document;
transmitting said electronic document to the first party and the second party; and
creating and storing a digital copy of each of said transmitted electronic documents as a HyperText Markup Language (HTML) file.

8. The method recited in claim 7 further comprising the steps of:
uploading at least one digital picture file; and
storing said at least one digital picture file on said digital copy of each of said transmitted electronic documents.

9. The method as recited in claim 8 wherein said at least one digital picture file is a digital video file.

10. The method as recited in claim 7 wherein said at least one manually-entered datum is an inspection report.

11. The method as recited in claim 7 further comprising the step of allowing each of the first, second and third parties to accept the at least one manually-entered datum.

12. The method as recited in claim 7 further comprising the step of allowing each of said first, second and third parties to accept or reject the opposing parties' comments.
